(19) United States
(12) Patent Application Publication
(10) Pub. No.: US 2026/0269400 A1
(43) Pub. Date: Sep. 10, 2026

(54) TRACTION BATTERY PACK ASSEMBLY WITH STRAIN RELIEF FEATURES

(71) Applicant: Ford Global Technologies, LLC, Dearborn, MI (US)

(72) Inventors: Patrick Daniel Maguire, Ann Arbor, MI (US); Deanna Marie Winton Hoffman, Ann Arbor, MI (US)

(21) Appl. No.: 19/304,664

(22) Filed: Aug. 20, 2025

Related U.S. Application Data
(60) Provisional application No. 63/766,671, filed on Mar. 4, 2025.

(51) Int. Cl. H01M 50/242; H01M 10/613; H01M 10/625; H01M 10/643; H01M 10/6568; H01M 50/213; H01M 50/249; H01M 50/291; B60L 50/64

(52) U.S. Cl. CPC H01M 50/242; H01M 10/613; H01M 10/625; H01M 10/643; H01M 10/6568; H01M 50/213; H01M 50/249; H01M 50/291; B60L 50/64; H01M 2220/20

(57) ABSTRACT

A traction battery pack assembly includes an enclosure section and a plurality of cell sleeves each having a cell receiving opening configured to receive one or more battery cells. The cell sleeves are each connected to the enclosure section and extend longitudinally away from the enclosure section. The assembly further includes strain relief features configured to accommodate movements of the plurality of cell sleeves relative to the enclosure section, relative to each other, or both.

### CROSS-REFERENCE TO RELATED APPLICATIONS

This application claims the benefit of U.S. Provisional Application No. 63/766,671, filed 4 Mar. 2025, the entirety of which is herein incorporated by reference.

### TECHNICAL FIELD

This disclosure relates generally to holding battery cells of a traction battery pack, and more particularly, to holding the battery cells utilizing cell sleeves and incorporating strain relief features to accommodate movement of the cell sleeves.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

In some aspects, the techniques described herein relate to a traction battery pack assembly, including: an enclosure section; a plurality of cell sleeves each having a cell receiving opening configured to receive one or more battery cells, the plurality of cell sleeves each connected to the enclosure section and extending longitudinally away from the enclosure section; and a plurality of strain relief features configured to accommodate movement of the plurality of cell sleeves relative to the enclosure section, relative to each other, or both.

In some aspects, the techniques described herein relate to a traction battery pack assembly, wherein the plurality of cell sleeves are a plurality of extruded cell sleeve assemblies.

In some aspects, the techniques described herein relate to a traction battery pack assembly, wherein the enclosure section is disposed along a plane, wherein the plurality of cell sleeves each extend longitudinally in a direction transverse to the plane.

In some aspects, the techniques described herein relate to a traction battery pack assembly, wherein the plurality of cell sleeves each extend perpendicularly to the plane.

In some aspects, the techniques described herein relate to a traction battery pack assembly, wherein the one or more battery cells are cylindrical battery cells.

In some aspects, the techniques described herein relate to a traction battery pack assembly, wherein the plurality of cell sleeves are immersed in a liquid coolant.

In some aspects, the techniques described herein relate to a traction battery pack assembly, wherein the plurality of cell sleeves are disposed within an enclosure assembly, the enclosure assembly providing the enclosure section.

In some aspects, the techniques described herein relate to a traction battery pack assembly, wherein the plurality of cell sleeves directly contact a liquid coolant within an interior of the enclosure assembly.

In some aspects, the techniques described herein relate to a traction battery pack assembly, wherein the plurality of strain relief features includes a plurality of corrugations in enclosure section.

In some aspects, the techniques described herein relate to a traction battery pack assembly, wherein the plurality of corrugations are waves in the enclosure section.

In some aspects, the techniques described herein relate to a traction battery pack assembly, wherein the waves are spaced from the plurality of cell sleeves.

In some aspects, the techniques described herein relate to a traction battery pack assembly, wherein the plurality of cell sleeves each include at least one sidewall extending circumferentially about the cell receiving opening, wherein the plurality of strain relief features includes a plurality of thinned areas within the at least one sidewall.

In some aspects, the techniques described herein relate to a traction battery pack assembly, wherein the plurality of thinned areas are each disposed circumferentially between thicker areas of the at least one sidewall.

In some aspects, the techniques described herein relate to a traction battery pack assembly, wherein the plurality of thinned areas each project radially outward further than the thicker areas of the at least one sidewall.

In some aspects, the techniques described herein relate to a traction battery pack assembly, wherein the plurality of cell sleeves each include a flared region, the plurality of strain relief features provided by the flared region.

In some aspects, the techniques described herein relate to a traction battery pack assembly, wherein the flared region is connected directly to the enclosure section.

In some aspects, the techniques described herein relate to a traction battery pack assembly, wherein plurality of cell sleeves are each configured to receive at least one cylindrical battery cell within a respective cell receiving opening, the at least one cylindrical battery cell held at position where the at least one cylindrical battery cell is spaced from the flared region.

In some aspects, the techniques described herein relate to a traction battery pack assembly, wherein the enclosure section is part of an enclosure assembly that provides an interior area, the plurality of cell sleeves immersed within a liquid coolant within the interior area.

In some aspects, the techniques described herein relate to a traction battery pack assembly, including: an enclosure assembly providing an interior area, the enclosure assembly having a first wall and an opposite second wall; a plurality of cell sleeves spanning from the first wall to the opposite second wall, each of the cell sleeves having a cell receiving opening; at least one battery cell received within each cell receiving opening; and a plurality of compliance regions, each compliance region being configured to permit limited flexing of the cell sleeves relative to one another.

In some aspects, the techniques described herein relate to a traction battery pack assembly, wherein the plurality of cell sleeves are immersed in a liquid coolant within the interior area.

### BRIEF DESCRIPTION OF THE DRAWINGS

FIG. 1 schematically illustrates an electrified vehicle.

FIG. 2 illustrates a plurality of cylindrical battery cells relative to the electrified vehicle of FIG. 1.

FIG. 3 illustrates a perspective view of selected portions of a traction battery pack from the electrified vehicle of FIG. 1.

FIG. 4 illustrates an expanded, perspective view of the portions of the traction battery pack shown in FIG. 3.

FIG. 5 illustrates a perspective view of the of an enclosure tray and a plurality of cell sleeves of the traction battery pack of FIGS. 3 and 4 according to an exemplary aspect of the present disclosure.

FIG. 6 illustrates a top view of the enclosure tray and the plurality of cell sleeves shown in FIG. 5.

FIG. 7 illustrates a close up view of a portion of FIG. 6.

FIG. 8 illustrates a section view taken at line 8-8 in FIG. 7.

FIG. 9 illustrates a top view of a cell sleeve according to another exemplary aspect of the present disclosure.

FIG. 10 illustrates a perspective view of a cell sleeve according to another exemplary aspect of the present disclosure.

### DETAILED DESCRIPTION

This disclosure relates generally to holding battery cells within a traction battery pack and, in particular, to holding the battery cells using cell sleeves and incorporating strain relief features that permit some movement of the cell sleeves. The cell sleeves can extend from a section of an enclosure assembly, such as a bottom wall or tray of the enclosure assembly. The strain relief features can accommodate movement of the cell sleeves relative to the enclosure section, relative to each other, or both.

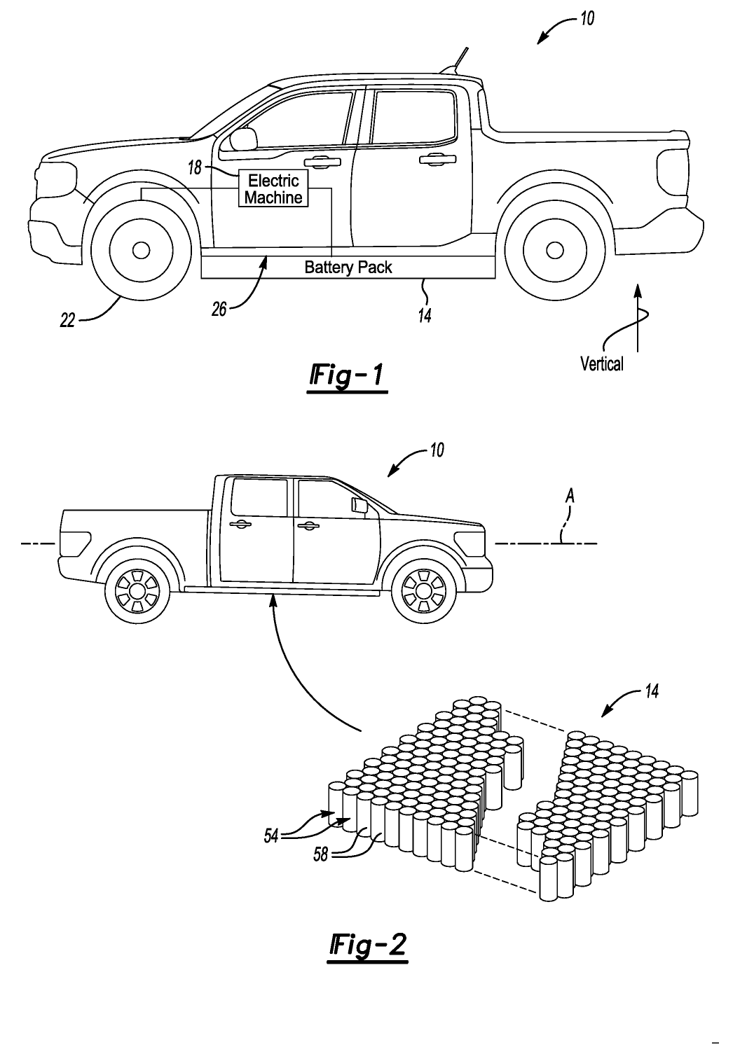

With reference to FIG. 1, an electrified vehicle 10 includes a battery pack 14, an electric machine 18, and wheels 22. The battery pack 14 powers the electric machine 18, which can convert electrical power to mechanical power to drive the wheels 22. The battery pack 14 is thus a traction battery pack.

The battery pack 14 is, in the exemplary embodiment, secured to an underbody 26 of the electrified vehicle 10. The battery pack 14 could be located elsewhere on the electrified vehicle 10 in other examples.

The example electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference to FIG. 2, the battery pack 14 includes a plurality of individual battery cells 54. Each of the battery cells 54 has an outer case 58, which can be a metal or metal alloy. The outer cases 58 are cylindrical, or substantially cylindrical, in this example. The battery cells 54 may be referred to as cylindrical battery cells. The battery cells 54 include terminals configured to electrically couple to other battery cells 54 and/or busbars, as examples, adjacent a common side thereof, which in this example is a top side.

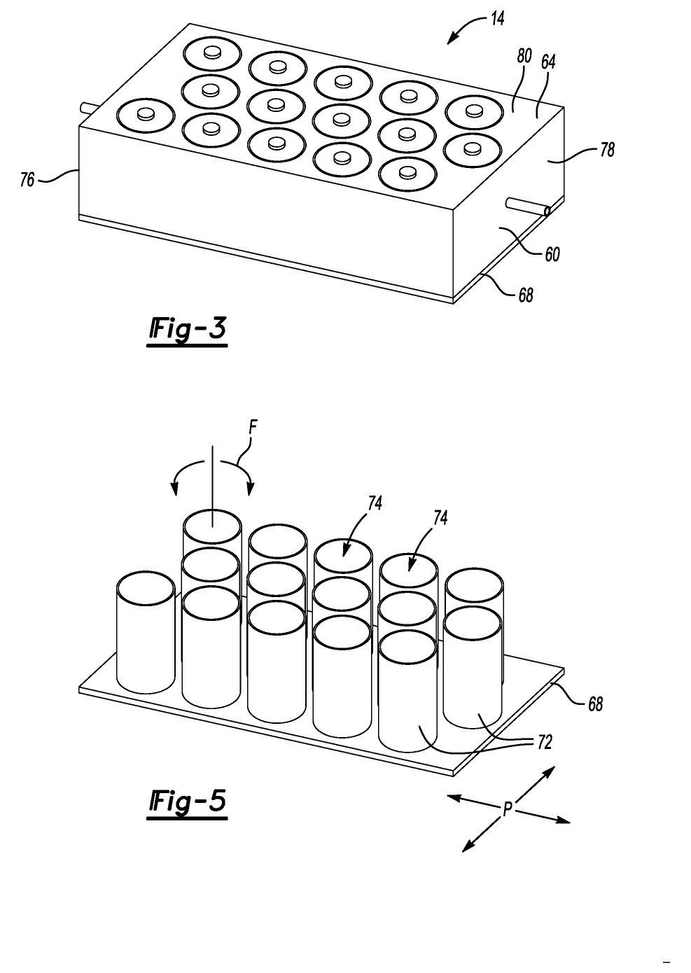

With reference now to FIGS. 3–5, the battery pack 14 includes an enclosure assembly 60 having an enclosure cover 64 and an enclosure tray 68 that meet to establish an interior area. The enclosure assembly 60 includes various sections. In the exemplary embodiment, the enclosure cover 64 is an enclosure section of the enclosure assembly 60. The enclosure tray 68 is another enclosure section of the enclosure assembly 60.

The battery pack 14 includes a plurality of cell sleeves 72 that are, in this example, connected to the enclosure tray 68. In another example, the cell sleeves 72 could be connected instead or additional to the enclosure cover 64, or to some other enclosure section of the enclosure assembly 60.

The cell sleeves 72 can be a polymer-based material. The cell sleeves 72 can be extruded. The cell sleeves 72 each include a cell receiving opening 74 configured to receive one or more of the battery cells 54. A diameter D of the cell receiving opening 74 can be consistent along a length of the cell sleeve 72.

The enclosure assembly 60 can be a polymer-based material. Securing the cell sleeves 72 to the enclosure tray 68 can occur utilizing vibration welds, adhesive, or some other connection technique.

In this example, the battery cells 54 are arranged within rows R1-R3. The rows R1-R3 each generally extend from a first end wall 76 of the enclosure cover 64 to a second end wall 78 of the enclosure cover 64. While there are three rows R1-R3 in this example, this disclosure extends to battery packs with different numbers of rows. Further, this disclosure is not limited to the particular number of battery cells 54 in a particular row.

Rows R1-R3 are generally parallel to one another, and optionally, parallel to a longitudinal axis of the vehicle 10. Adjacent rows R1-R3 are staggered relative to one another to enable closer packaging of the battery cells 54, which results in battery cells 54 having a general honeycomb arrangement.

In this example, the battery cells 54 are arranged such that electrical connections between adjacent battery cells 54 are made adjacent a top wall 80 of the enclosure cover 64, and a venting arrangement for the battery cells 54 is arranged adjacent the enclosure tray 68. The venting arrangement can include openings that open in response to a venting event to permit vent byproducts to move through the enclosure tray 68.

The enclosure assembly 60 includes an inlet 82 through the first end wall 76 and an outlet 86 through the second end wall 78. Liquid coolant, such as water, can move through the inlet 82 into the interior area established between the enclosure cover 64 and the enclosure tray 68. Within the interior area, the fluid can pass over the cell sleeves 72. The thermal management fluid can exit from the interior area through the outlet 86. The thermal management fluid is circulated through the interior area to manage thermal energy levels of the battery cells 54 and other components of the battery pack 14.

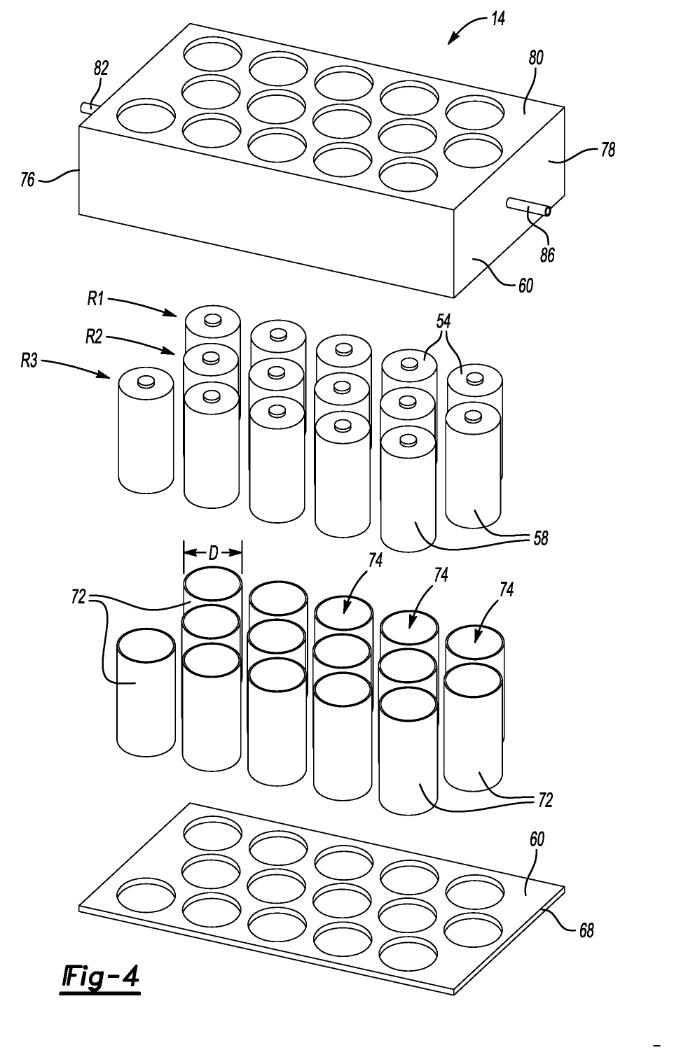

In this example, the enclosure tray 68 is disposed along a general plane P (FIG. 5). The cell sleeves 72 each extend longitudinally in a direction transverse to the plane P—here, the cell sleeves 72 extend vertically upward away from the plane P and the enclosure tray 68. The cell sleeves 72 extend perpendicularly to the plane P in this example.

In this example, during assembly, the cell sleeves 72 are connected to the enclosure tray 68. The cells 54 are then inserted into the cell sleeves 72. The cell sleeves 72 may flex F relative to each other and to the enclosure tray 68 when the battery cells 54 are inserted into an appropriate cell receiving opening 74. The enclosure cover 64 is placed over the cell sleeves 72 and may be connected to the cell sleeves 72. When assembled, the cell sleeves 72 thus span across the interior area of the enclosure assembly 60 from a first wall or enclosure tray 68 to an opposite second wall or enclosure cover 64. While shown as connected to the enclosure tray 68, the cell sleeves 72 could connect to other enclosure structures in other examples.

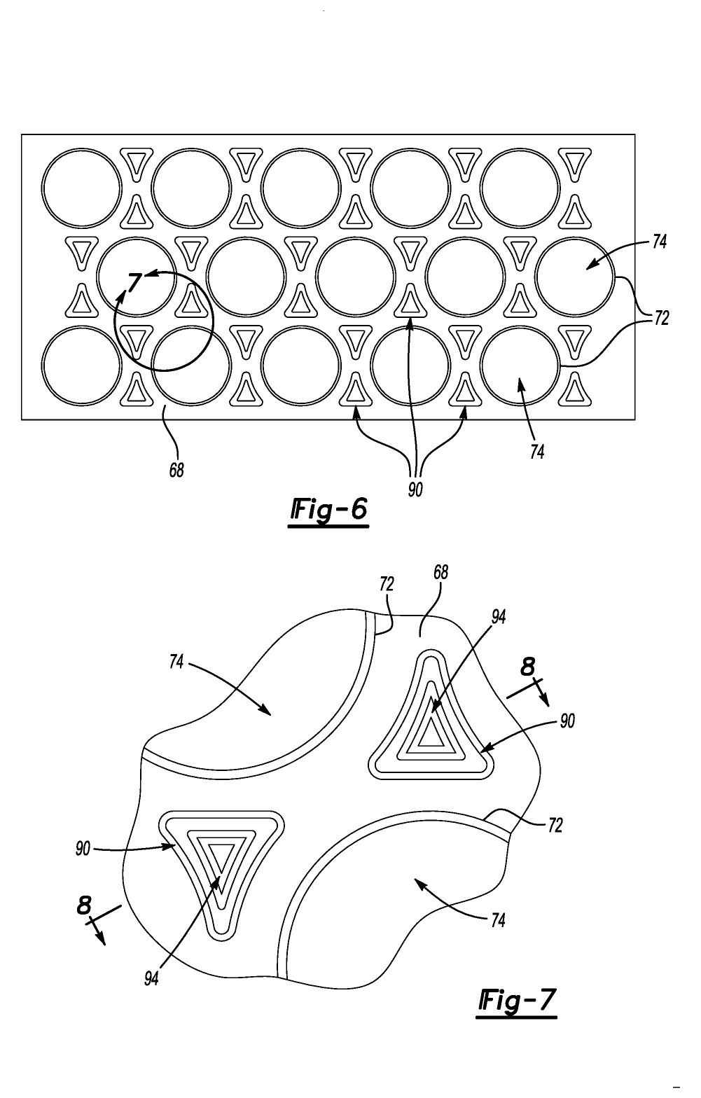

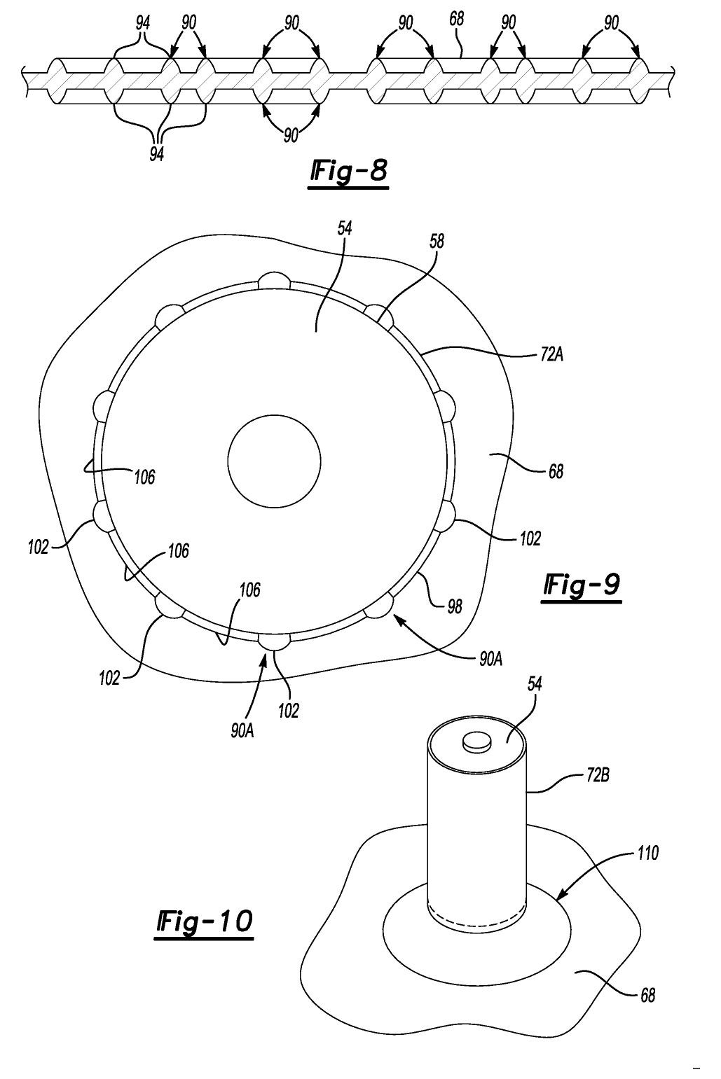

With reference now to FIGS. 6–8 and continuing reference to FIGS. 3–5, the example battery pack 14 incorporates strain relief features 90 that accommodate the flexing F and other movement of the cell sleeves 72 relative to the enclosure tray 68, relative to each other, or both. Other examples of movement could include non-uniform distortion (stretching) of portions of the cell sleeves 72.

The strain relief features 90 are, in the exemplary embodiment, incorporated into the enclosure section from which the cell sleeves 72 extend. Here, the strain relief features are incorporated into the enclosure tray 68. In particular, the strain relief features 90 are provided within the enclosure tray 68 between the cell sleeves 72.

The strain relief features 90 of the exemplary embodiment, are wavy or corrugated areas of the enclosure tray 68. The strain relief features 90 can be characterized as a plurality of corrugations 94. The plurality of corrugations 94 can be considered waves in the enclosure tray 68. The waves or corrugations 94 are spaced a distance from each of the cell sleeves 72.

As battery cells 54 are inserted into respective cell receiving openings 74, the corrugations 94 can facilitate some flexing of the cell sleeves 72 relative to each other and relative to the enclosure tray 68. The strain relief features 90—here the corrugations 94—accommodate the flexing and relative movement of the cell sleeves 72 so that the cell sleeves 72 and the enclosure tray 68 remain intact.

While described in connection with flexing as battery cells 54 are inserted into the cell receiving openings 74 of the cell sleeves 72, a person having skill in this art and the benefit of this disclosure would understand that the strain relief features 90 could accommodate relative movement of the cell sleeves 72 at other times, such as when the immersion fluid is circulated through the interior area of the enclosure assembly 60 and contacting outer surfaces of the cell sleeves 72.

With reference now to FIG. 9, in another exemplary embodiment, a plurality of cell sleeves 72A each include at least one sidewall 98 extending circumferentially about the associated cell receiving opening 74. Strain relief features 90A are provided by a plurality of thinned areas 102 within the sidewall 98 The thinned areas 102 are each disposed circumferentially between thicker areas 106 of the at least one sidewall 98. The cell sleeves 72A can be extruded cell sleeves.

In the exemplary embodiment, the plurality of thinned areas 102 project radially outward further than the thicker areas 106 of the at least one sidewall 98. The thinned areas 102 help the cell sleeves 72A flex radially outward when inserting the cells 54 into the associated cell receiving opening 74 and at other times. The thinned areas 102 can allow the thicker areas 106 to move slightly relative to each other as the battery cells 54 are inserted into the cell receiving openings 74. The sidewall 98 with thinned areas 102 and thicker areas 106 can accommodate variations in diameters of battery cells 54.

With reference now to FIG. 10, in another exemplary embodiment of the present disclosure, a plurality of cell sleeves 72B can each include a flared region 110 as a strain relief feature 90B. In this example, the plurality of cell sleeves 72B each connect to the enclosure tray 68 through a respective flared region 110. The flared region 100 can permit some flexing of the associated cell sleeve 72B relative to the other cell sleeves 72B and other structures.

In the exemplary embodiment, the battery cells 54 are received within the cell sleeves 72B at a position where the battery cells 54 are spaced outside the flared region 110. In this example, the battery cells 54 are above the flared regions 110 of the cell sleeves 72B.

The corrugations 94 in the enclosure tray 68 in the embodiment of FIGS. 3–8, the thinned areas 102 of the embodiment of FIG. 9, and the flared region 110 of the cell sleeve 72B in the embodiment of FIG. 10, are all types of strain relief features incorporated into structures of the battery pack 14 to accommodate strain and relieve strain associated with relative movement of cell sleeves so that the strain does not introduce performance degrading issues, leak paths, etc. In some examples, the strain relief features are characterized as compliance regions as they are associated with regions that allow for compliance of the cell sleeves.

One of ordinary skill in this art would understand that the above-described embodiments are exemplary and non-limiting. That is, modifications of this disclosure would come within the scope of the claims. Accordingly, the following claims should be studied to determine their true scope and content.

1. A traction battery pack assembly, comprising:
an enclosure section;
a plurality of cell sleeves each having a cell receiving opening configured to receive one or more battery cells, the plurality of cell sleeves each connected to the enclosure section and extending longitudinally away from the enclosure section; and
a plurality of strain relief features configured such that at least one strain relief feature is associated with a corresponding one of the plurality of cell sleeves, the strain relief features being configured to accommodate movement of the corresponding cell sleeve relative to the enclosure section, relative to other cell sleeves, or both.

2. The traction battery pack assembly of claim 1, wherein the plurality of cell sleeves are a plurality of extruded cell sleeve assemblies.

3. The traction battery pack assembly of claim 1, wherein the enclosure section is disposed along a plane, wherein the plurality of cell sleeves each extend longitudinally in a direction transverse to the plane.

4. The traction battery pack assembly of claim 3, wherein the plurality of cell sleeves each extend perpendicularly to the plane.

5. The traction battery pack assembly of claim 1, wherein the one or more battery cells are cylindrical battery cells.

6. The traction battery pack assembly of claim 1, wherein the plurality of cell sleeves are immersed in a liquid coolant.

7. The traction battery pack assembly of claim 1, wherein the plurality of cell sleeves are disposed within an enclosure assembly, the enclosure assembly providing the enclosure section.

8. The traction battery pack assembly of claim 7, wherein the plurality of cell sleeves directly contact a liquid coolant within an interior of the enclosure assembly.

9. The traction battery pack assembly of claim 1, wherein the plurality of strain relief features comprises a plurality of corrugations in enclosure section.

10. The traction battery pack assembly of claim 9, wherein the plurality of corrugations are waves in the enclosure section.

11. The traction battery pack assembly of claim 10, wherein the waves are spaced from the plurality of cell sleeves.

12. The traction battery pack assembly of claim 1, wherein the plurality of cell sleeves each include at least one sidewall extending circumferentially about the cell receiving opening, wherein the plurality of strain relief features comprises a plurality of thinned areas within the at least one sidewall.

13. The traction battery pack assembly of claim 12, wherein the plurality of thinned areas are each disposed circumferentially between thicker areas of the at least one sidewall.

14. The traction battery pack assembly of claim 13, wherein the plurality of thinned areas each project radially outward further than the thicker areas of the at least one sidewall.

15. The traction battery pack assembly of claim 1, wherein the plurality of cell sleeves each include a flared region, the plurality of strain relief features provided by the flared region.

16. The traction battery pack assembly of claim 15, wherein the flared region is connected directly to the enclosure section.

17. The traction battery pack assembly of claim 16, wherein plurality of cell sleeves are each configured to receive at least one cylindrical battery cell within a respective cell receiving opening, the at least one cylindrical battery cell held at position where the at least one cylindrical battery cell is spaced from the flared region.

18. The traction battery pack assembly of claim 16, wherein the enclosure section is part of an enclosure assembly that provides an interior area, the plurality of cell sleeves immersed within a liquid coolant within the interior area.

19. A traction battery pack assembly, comprising:
an enclosure assembly providing an interior area, the enclosure assembly having a first wall and an opposite second wall;
a plurality of cell sleeves spanning from the first wall to the opposite second wall, each of the cell sleeves having a cell receiving opening;
at least one battery cell received within each cell receiving opening; and
a plurality of compliance regions, each compliance region being configured to permit limited flexing of the cell sleeves relative to one another.

20. The traction battery pack assembly of claim 19, wherein the plurality of cell sleeves are immersed in a liquid coolant within the interior area.
